(19) United States
(12) Patent Application Publication
(10) Pub. No.: US 2013/0144626 A1
(43) Pub. Date: Jun. 6, 2013

(54) RAP MUSIC GENERATION

(71) Applicant: David Shau, Palo Alto, CA (US)

(72) Inventor: David Shau, Palo Alto, CA (US)

(21) Appl. No.: 13/310,757

(22) Filed: Dec. 4, 2011

(51) Int. Cl. G10L 11/00

(52) U.S. Cl. 704/270; 704/E11.001

(57) ABSTRACT

The preferred embodiments of this invention convert common human speeches into rap music. Computer programs change the timing intervals, amplitudes, and/or frequencies of the sound signals of a common speech to follow rap music beats. The resulting rap music also can overlap with background music and/or video images to achieve better effects.

### BACKGROUND OF THE INVENTION

The present invention relates to methods and structures for generating rap music, and more particularly to methods and structures for converting common speeches into rap music.

I enjoy rap music very much, but I am not a good rapper. Whenever I rap, it dose not sound as good as those professional rappers like Snoop Dawg or 50 Cent. As a matter of fact, most of time my rapping sounds terrible. Although professional raps are nice to listen to, I think it would still be nice to here my own voice rap. I could add electronic voices and other cool effects to make it seem like a real rap. Buying rap songs from the big rappers can sometimes be really expensive, and I personally think that the lyrics are often disturbing or even a bit dumb. Rap is mostly depending on the beat and rhythm. With this patent, I could use my own lyrics and I would be able to listen to it and still enjoy it at a lower cost. The song would be under my control. I could customize it anyway I want. The rhythm would be on the beat that I desire, and the special effects and music will make it seem more enjoyable and cool to me. Using this as an application program for smart phones can also be really fun. When someone calls the owner, they will be able to record the phone call and turn it into a rap song. You would also be able to do this with Skype and other computer chatting programs. Sometimes I have to listen to lectures or lessons online, which can be very boring. If I could make the lecture rap, then it would be much more fun to listen to. Answering machines can also rap the messages that were sent by phone calls as well. It is therefore highly desirable to convert common speeches into rap music.

### SUMMARY OF THE PREFERRED EMBODIMENTS

A primary objective of the preferred embodiments is, therefore, to convert a common human speech into rap music. An objective of the preferred embodiment is to generate rap music while preserving the original voice of the speaker. Another objective of the preferred embodiment is to achieve better rap music effects using signal processing methods. An objective of the preferred embodiment is to convert a lecture into rap music. Another objective of the preferred embodiment is to convert telephone messages, such as incoming messages, answering messages, voice mail messages, or speech ring tunes into rap music. These and other objectives are assisted by using computer programs to change the timing intervals, amplitudes, and/or frequencies of the sound signals of a common speech in order to create rap music effects.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1(a) shows the symbolic block diagram of an exemplary embodiment of the present invention;

FIG. 1(b) is an exemplary flow chart for the operation procedures of the system in FIG. 1(a);

FIGS. 2(a-h) are simplified sound signal waveforms of exemplary embodiments of the present invention; and

FIGS. 3(a-e) are simplified flow charts for the operation procedures of exemplary embodiments of the present invention.

### DETAILED DESCRIPTION OF THE PREFERRED EMBODIMENTS

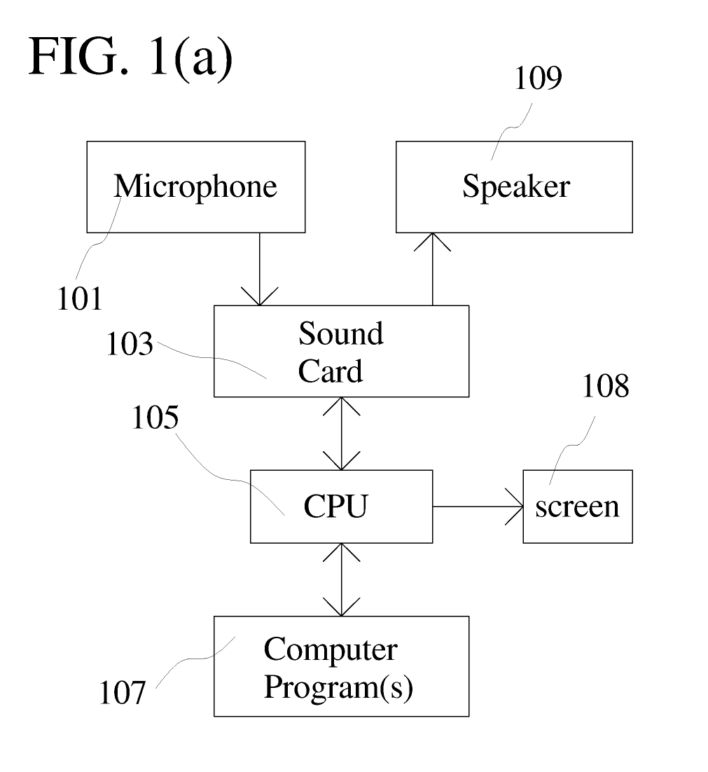

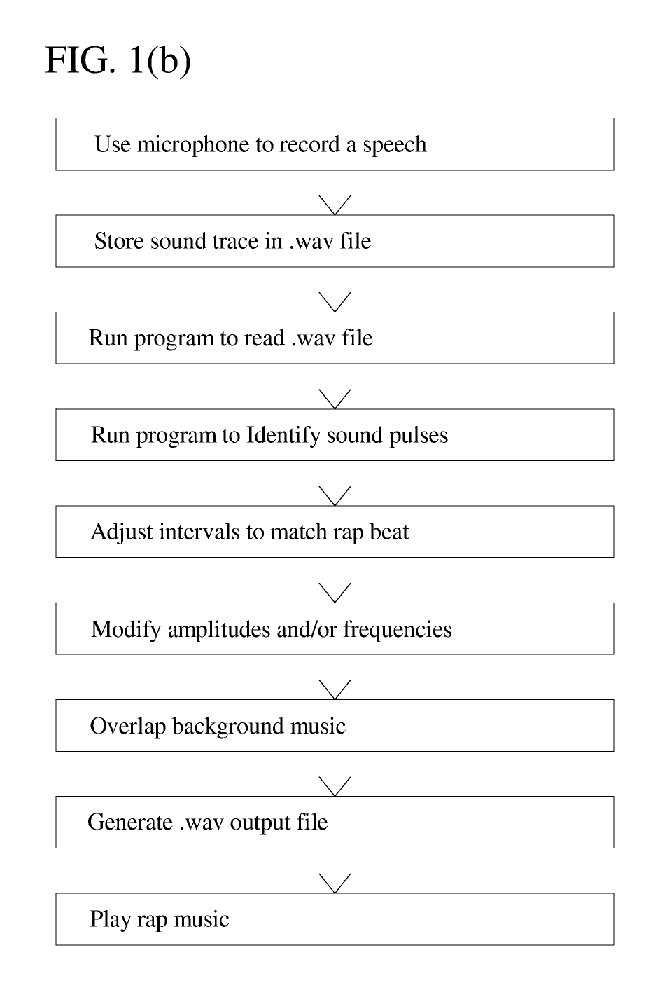

FIG. 1(a) is a simplified symbolic block diagram for an exemplary embodiment of the present invention. In this example, one or more microphones (101) are used to convert the sound of a human speech into electrical signals. A speech, by definition used in this patent application, is a plurality of spoken words that are understandable by human. Typical human speeches are not in rap music rhythm. In this example, a sound card (103) converts the microphone signals into digital data, and sends the data to the central processing unit (CPU), which is typically an integrated circuit device such as a microprocessor or a digital signal processor. The CPU (105) processes the data, outputs the sound signals into digital data stream(s) that can be processed by computer program(s), and save the data stream(s) in sound trace files. Typical examples of sound trace files are: Moving Picture Experts Group Audio Layer III (MP3) files, Windows Media Audio (.wma) files used in Microsoft Windows, wave form audio (.wav) files used in older versions of Microsoft Windows, and many other types of sound trace files. We certainly can use customized sound trace files. It is certainly possible to process the sound data streams without using a sound trace file. While in digital formats, computer programs (107) can read sound trace files and display the sound waveforms on a screen (108). A waveform, by definition used in this patent application, is a stream of data that represents amplitudes as a function of time. The computer programs (107) also can read the original sound data stream(s) of a speech that was not in rap rhythm, and generate rap music. In this example, the computer programs (107) output a rap music sound trace file that is also in .wav format. The CPU (106) can read the rap music sound trace file, and send digital signals to the sound card (103) which can play the rap music using a speaker (109). It is often desirable to display video images of dancers on the screen (108) to enhance the effects of the generated rap music. The system shown in FIG. 1(a) can be implemented in lap-top computers, desk top computers, notebook computers, pocket computers, mobile phones, vehicle sound systems, electrical books, and many other electrical devices that are equipped with audio functions.

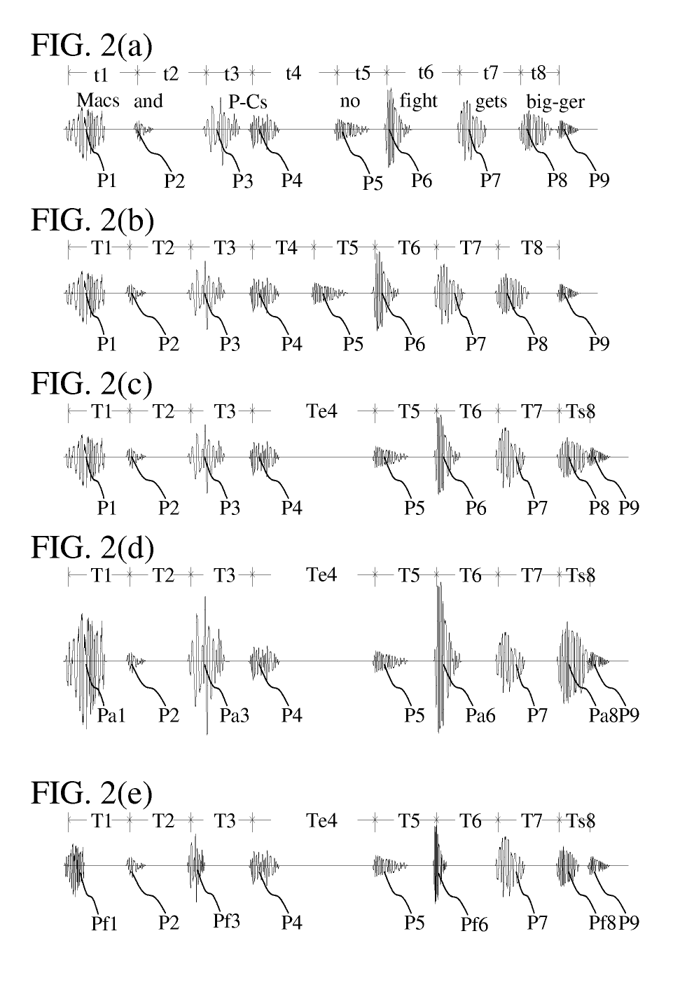

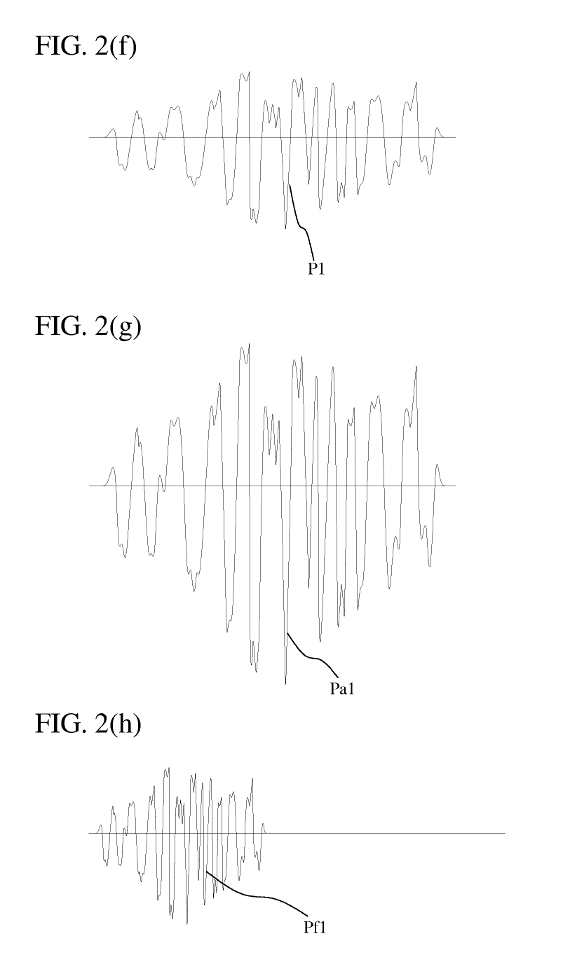

The operation procedures for the system shown in FIG. 1(a) are illustrated by the flow chart in FIG. 1(b) and the sound signal waveforms shown in FIGS. 2(a-h). In this example, Microsoft “Recorder” program is used to record a common speech that was originally not in rap music rhythm, and outputs digital sound data streams of the speech into a .wav file, as shown in the exemplary flow chart in FIG. 1(b). Exemplary sound signal waveforms of a common human speech are illustrated by the simplified diagram in FIG. 2(a). In this example, the words spoken in the speech were “Macs and PCs, no fight gets bigger”. The words in the speech are marked on the top of the corresponding waveforms in FIG. 2(a). Typically, syllables of the words in the speech corresponding to pulses (P1-P9) of sound signals, which will be called “syllable pulses” in the following discussions. For common human speech, the original time intervals (t1-t8) between syllable pulses (P1-P9) are typically not in regular intervals, as illustrated by the exemplary waveforms in FIG. 2(a). Computer programs can read the sound trace file, and analyze the digital data streams to identify syllable pulses, as shown by the flow chart in FIG. 1(b). Sometimes the pulses of the sound signals in a speech are not as well defined as those shown in the above example. Other signals such as background noise or electrical noise can make it more difficult to identify syllable pulses in a common speech. Sometimes, two nearby syllable pulses can interfere with each other to make it more difficult to identify them. However, current art signal processing technologies typically are able to screen out those none-ideal effects and identify syllable pulses in the sound signals of a human speech.

In order to generate rap music, a rap music beat is typically selected as the timing reference. Selection of rap music beat(s) can happen before or after recording of a speech. The rap music beat can be one of the commercial rap music beats, or a customer beat generated by individual users. A music beat typically has a repeating pattern of pre-defined timing intervals between pulses. For clarity, simple beats of equal time intervals are illustrated in the following examples, while the methods are certainly applicable to support complex rap music beats. It is certainly possible to combine multiple rap music beats to support conversion of a single speech.

As shown by the flow chart in FIG. 1(b), computer programs are executed to adjust the time intervals between pulses (P1-P9) of sound signals corresponding to syllables in human speech to match the timing of selected rap music beats. For example, the program can change the original random time intervals (t1-t8) in FIG. 2(a) into equal intervals (T1-T8), as shown by the waveforms in FIG. 2(b). Sound traces with regulated intervals that follow rap music beat(s) display musical rhythm to human ears. The average time of the adjusted time intervals (T1-T8) can be faster or slower than that of the original time intervals (t1-t8). This example is simplified for clarity; more modifications can be applied to achieve additional rap music effects. While most of the pulses (P1-P9) are adjusted to follow rap music beat(s), sometimes we can have exceptions. For example, we can insert an empty beat between P4 and P5 to increase the time interval (Te4) between P4 and P5, as shown in FIG. 2(c). Inserting such “silent syllable” is commonly used between sections of a speech, or to emphasize the following syllable. We also can shorten the interval (Ts8) between P8 and P9, as shown in FIG. 2(c). Shortened intervals are commonly used for multiple-syllable words, or to weaken the following syllable.

While the preferred embodiments have been illustrated and described herein, other modifications and changes will be evident to those skilled in the art. It is to be understood that there are many other possible modifications and implementations so that the scope of the invention is not limited by the specific embodiments discussed herein. For example, the microphone and the sound card or the CPU does not need to be in the same electrical device; the sound signals detected by microphone(s) can be transferred through wired or wireless communication systems to a remote device before the recorded speech is converted into rap music. The sound signals also can be stored in a storage device such as a compact disk, a nonvolatile memory device, a tape, or a floppy disk before computer programs in another device converts the stored speech into rap music. The microphone(s) can be built-in microphone(s) in a computer, a telephone, or other types of electrical devices; it also can be a separated microphone.

In an embodiment of the present invention, the time interval of the syllables in a speech are changed to substantially follow rap music beat in order to display musical rhythms, but small portion of the syllables are allowed not to follow beats; sometimes those exceptions can be introduced intentionally for additional sound effects. The present invention does not require 100% of the syllable pulses to follow beats. In the above examples, time intervals between sound pulses are changed while the waveforms of the pulses remain unchanged. In this way, the original voice of the speaker is preserved while the rhythm is changed. Typically, in this way, one can still recognize the voice of the originally speaker while it is changed to follow rap music rhythm. Sometimes it is desirable to change the original waveforms to achieve additional musical effects. FIG. 2(d) shows an example when the amplitudes of 4 pulses (Pa1, Pa3, Pa6, Pa8) are increased while other pulses (P2, P4, P5, P7, P9) remain the same. FIG. 2(f) shows the detailed waveform of the first pulse (P1) in FIG. 2(c), while FIG. 2(g) shows the detailed waveform of the first pulse (Pa1) in FIG. 2(d). Comparing FIG. 2(g) with FIG. 2(f), we can see that the general shapes of the waveform (Pa1) in FIG. 2(g) remain similar to that in FIG. 2(f) except the amplitudes of the pulse waveforms is increased. The sound trace in FIG. 2(d) would therefore display a strong-weak-strong-weak rhythm instead of the even amplitude rhythm in FIG. 2(c). FIG. 2(e) shows another example when the frequencies of 4 pulses (Pf1, Pf3, Pf6, Pf8) are increased while other pulses (P2, P4, P5, P7, P9) remain the same. FIG. 2(h) shows the detailed waveform of the first pulse (Pf1) in FIG. 2(e). Comparing FIG. 2(h) with FIG. 2(f), we can see that the general shapes of the waveform (Pf1) in FIG. 2(h) remain similar to that in FIG. 2(f) except the duration of the pulse is reduced, which is equivalent to increase the frequencies in sound spectrum. The sound trace in FIG. 2(b) would display a high-low-high-low pitch instead of the even pitch rhythm in FIG. 2(c). These examples are simplified for clarity, while practical waveforms can be more complex.

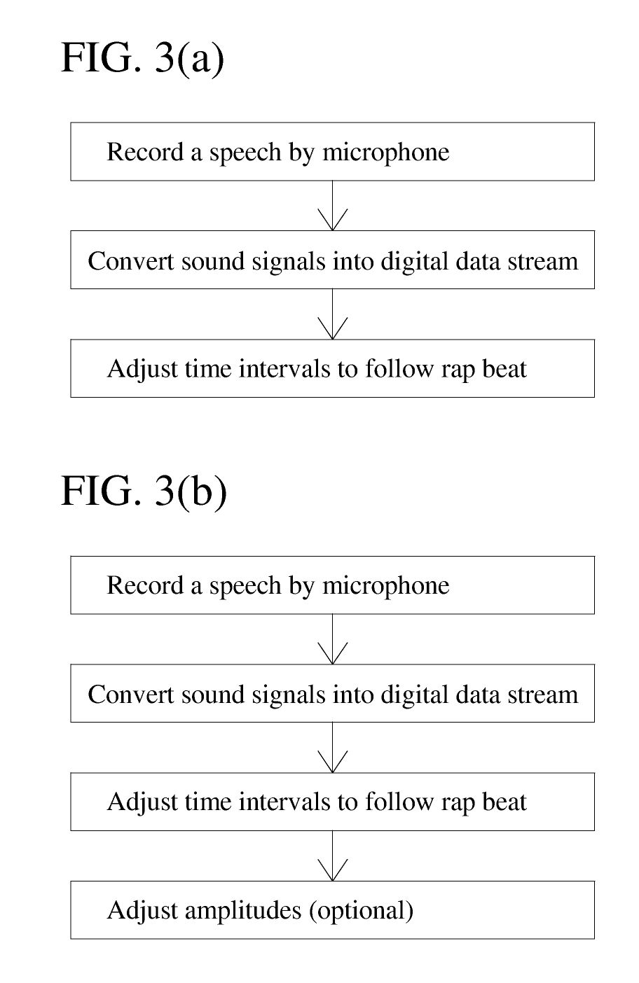

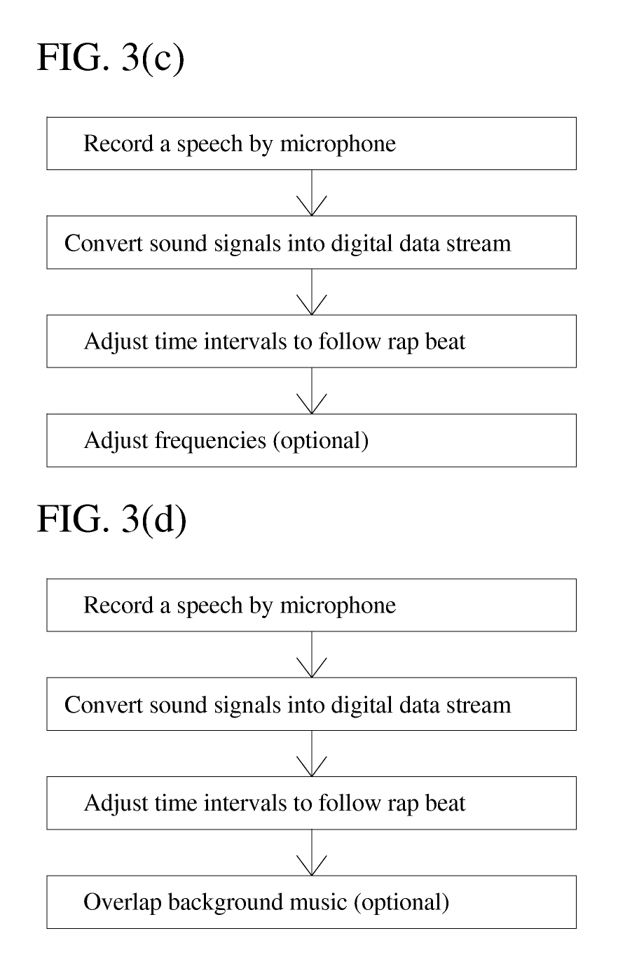

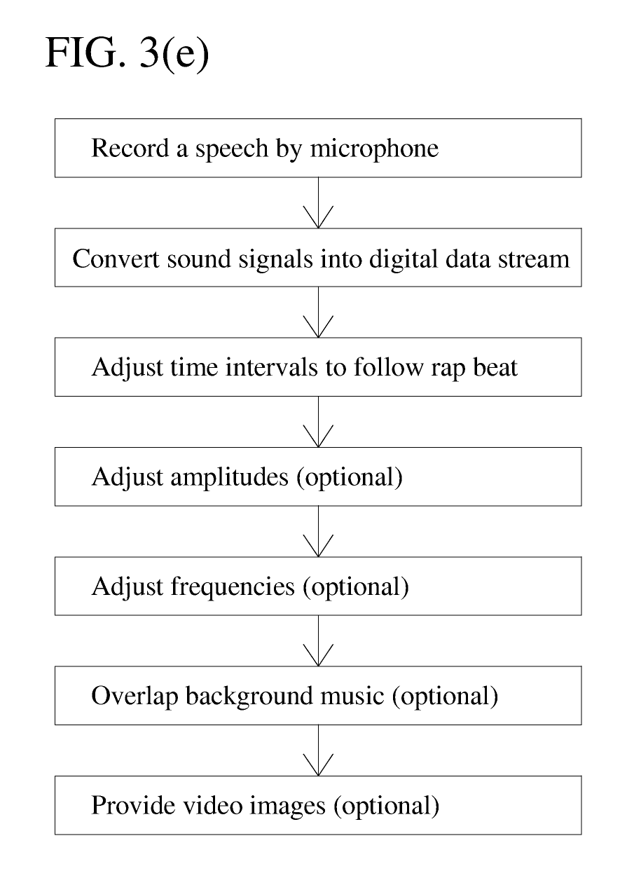

FIG. 3(a) shows a simplified flow chart for basic operation procedures of exemplary embodiments of the present invention. A human speech is typically recorded by microphone(s) to convert sound into electrical signals. The human speech originally was not in rap music rhythm. Electrical devices such as a sound card or integrated circuits are used to convert the electrical signals detected by microphone(s) into digital data stream(s) that can be processed by computer programs, so that computer program(s) can process the digital data stream(s) to adjust the time intervals between the sound signals corresponding to the syllables of the words in the recorded human speech to substantially follow the rhythm of rap music beat(s) in order to generate rap music using words in the human speech. The computer programs can be software programs stored in mass storage devices, firmware programs stored in integrated circuits, or in other ways. Computer programs can be executed by computer, but they also can be executed by other types of electrical devices such as mobile phones, electrical books, televisions, terminals, and so on. Besides adjusting time intervals, the computer programs also can execute other functions such as noise cancelation, data formatting, data compaction . . . etc. Additional signal processing also can be executed. For example, the computer programs can change the relative amplitudes of parts or all of the sound signals of the human speech to achieve additional musical effect, as shown by the flow chart in FIG. 3(b) or the exemplar waveform in FIG. 2(d). Such amplitude changes can be executed before or after adjustment of time intervals. For another example, the computer programs can change the frequencies of parts or all of the sound signals of the human speech to achieve additional musical effect, as shown by the flow chart in FIG. 3(c) or the exemplar waveform in FIG. 2(e). Such frequency changes can be executed before or after adjustment of time intervals. Another useful effect is to overlap background music with the rap music generated from the sound signals of the human speech, as shown by the flow chart in FIG. 3(d). We certainly can combine the effects of interval, amplitude, and frequency changes in any order to achieve better effects, as shown by the exemplary flow chart in FIG. 3(e). Although computer programs can execute the rap music generation automatically, sometimes it is desirable to combine manual control with automatic control in order to customize the rap music generation procedures. Most of commercial rap music provides video images of dancers associated with the rap music. We certainly can provide video images for the rap music generated from the sound signals of the human speech, as shown by the flow chart in FIG. 3(e). The resulting rap music can be used as a telephone ring tone, a telephone answering message, a lecture, a greeting message, or many other applications.

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

What is claimed is:

1. A method for generating rap music, comprising the steps of:
Using one or more microphone(s) to convert the sound of a human speech into electrical signals, where said human speech originally was not in rap music rhythm;
Converting said electrical signals detected by microphone(s) into digital data stream(s) that can be processed by computer program(s);
Using computer program(s) to process said digital data stream(s), wherein said computer program(s) adjust the time intervals between the sound signals corresponding to the syllables of the words in said human speech to substantially follow the rhythm of rap music beat(s) in order to generate rap music using words in said human speech.

2. The method in claim 1 further comprises a step of using computer program(s) to change the relative amplitudes of parts or all of the sound signals of the human speech.

3. The method in claim 1 further comprises a step of using computer program(s) to change the frequencies of parts or all of the sound signals of the human speech.

4. The method in claim 1 further comprises a step of overlapping background music with the rap music generated from the sound signals of the human speech.

5. The method in claim 1 further comprises a step of providing video images for the rap music generated from the sound signals of the human speech.

6. The method in claim 1 comprises a step of using one or more microphone(s) in a computer to convert the sound of a human speech into electrical signals.

7. The method in claim 1 comprises a step of using one or more microphone(s) in a telephone to convert the sound of a human speech into electrical signals.

8. The method in claim 1 comprises further comprises a step of using the resulting rap music generated from human speech as a telephone ring tone.

9. The method in claim 1 comprises further comprises a step of using the resulting rap music generated from human speech as a telephone answering message.
